(19) United States
(12) Patent Application Publication
(10) Pub. No.: US 2006/0285445 A1
(43) Pub. Date: Dec. 21, 2006

(54) Date display assembly for an electronic device

(76) Inventors: Wolfgang Burkhardt, Ispringen (DE); Herbert Schwartz, Wurmberg (DE)

Correspondence Address: Arthur G. Schaier;Carmody & Torrance LLP, 50 Leavenworth Street, P.O. Box 1110, Waterbury, CT, 06721-1110, US

(21) Appl. No.: 11/453,587

(22) Filed: Jun. 14, 2006

Related U.S. Application Data
(60) Provisional application No. 60/691,914, filed on Jun. 17, 2005.
(60) Provisional application No. 60/754,854, filed on Dec. 29, 2005.

(51) Int. Cl. G04B 19/20

(52) U.S. Cl. 368/37

(57) ABSTRACT

A date display assembly for displaying the day of the month in an electronic device, the assembly comprising a units ring and a tens disc, the units ring comprising at least one series of numerals from 0 to 9 and the tens disc comprising a series of numerals from at least 1 to 3 and optionally the numeral 0; wherein the units ring and the tens disc being positioned relative to each other so as to display in the space of a window two numerals side by side, one of which is carried by the units ring and the other of which is carried by the tens disc, wherein the units ring is divided into ten sectors or a multiple of ten sectors each separating the numerals 0 to 9, the one sector separating the numerals 9-0 having an angular extent equal to ¾ of the angular extent of the sectors separating the other numerals. In the preferred embodiment, the device is a timepiece and a wristwatch in particular.

### RELATED APPLICATIONS

This application claims the benefit of U.S. Provisional Application Nos. 60/691,914, filed Jun. 17, 2005 and 60/754,854 filed Dec. 29, 2005.

### BACKGROUND OF THE INVENTION

The present invention relates to a date display assembly for displaying the day of the month, particularly for a timepiece of the type comprising a two-ring/disc (units, tens) assembly. Such an assembly, among other things, facilitates the use of large digits on the rings or discs, thereby providing, among other things, a more easily readable date/day display.

Constructions that use both a units ring and tens disc to display a two digit date are known, one such example being described in U.S. patent application Ser. No. 10/407,169. However, such constructions have perceived deficiencies. For example, it is believed that the construction set forth in the aforementioned published application requires an excessive amount of rotation of the tens disc (450°) when the date moves from “09” to “10,” “19” to “20” and “29” to “30.” Accordingly, it is believed that the rate at which the tens digit changes is slower than desirable and performed with less efficiency. Additionally, because of the needed gear ratio and number of teeth required in the prior art assembly, it is believed that the size of the units ring and/or the tens disc must be made larger than would otherwise be achievable and desirable.

Accordingly, it is believed that improvements to the state of the art are both achievable and desirable. The present invention provides said improvements, as well as achieves the objectives set forth throughout this application.

### SUMMARY OF THE PRESENT INVENTION

It is thus an objective of the present invention to provide an improved date display assembly that requires less rotation of the tens disc, thus minimizing the energy and rotation time needed, thereby simultaneously providing a more efficient and reliable date display methodology.

It is still another objective of the present invention to provide an improved date display assembly that provides for a cleaner and quicker rotation of the tens disc than achieved by the prior art constructions.

Further objects and advantages of this invention will become more apparent from a consideration of the drawings and ensuing description.

The invention accordingly comprises the features of construction, combination of elements and arrangement of parts that will be exemplified in the disclosure hereinafter set forth, and the scope of the invention will be indicated in the claims.

To overcome the perceived deficiencies in the prior art and to achieve the objects and advantages set forth above and below, the present invention is, generally speaking, directed to a date display assembly for displaying the day of the month, comprising a units ring and a tens disc, the units ring comprising at least one series of numerals from 0 to 9 and the tens disc comprising a series of numerals from at least 1 to 3 and optionally the numeral 0; wherein the units ring and the tens disc are positioned relative to each other so as to display in the space of a window two numerals side by side, one of which is carried by the units ring and the other of which is carried by the tens disc, wherein the units ring is divided into ten sectors or a multiple of ten sectors each bearing a numeral from 0 to 9, the one sector separating the numerals 9 and 0 having an angular extent equal to ¾ of the angular extent of the sectors separating the other numerals. In accordance with the preferred embodiment, the present invention is incorporated into an electronic device, which is preferably a timepiece and a wristwatch in particular.

### BRIEF DESCRIPTION OF THE DRAWINGS

FIGS. 1 and 1A are views of a date display assembly constructed in accordance with the prior art;

FIG. 2 is a perspective view of a date display assembly constructed in accordance with a first embodiment of the present invention; and

FIG. 3 is a perspective view of a date display assembly constructed in accordance with an alternative embodiment of the present invention.

### DETAILED DESCRIPTION OF THE PREFERRED EMBODIMENTS

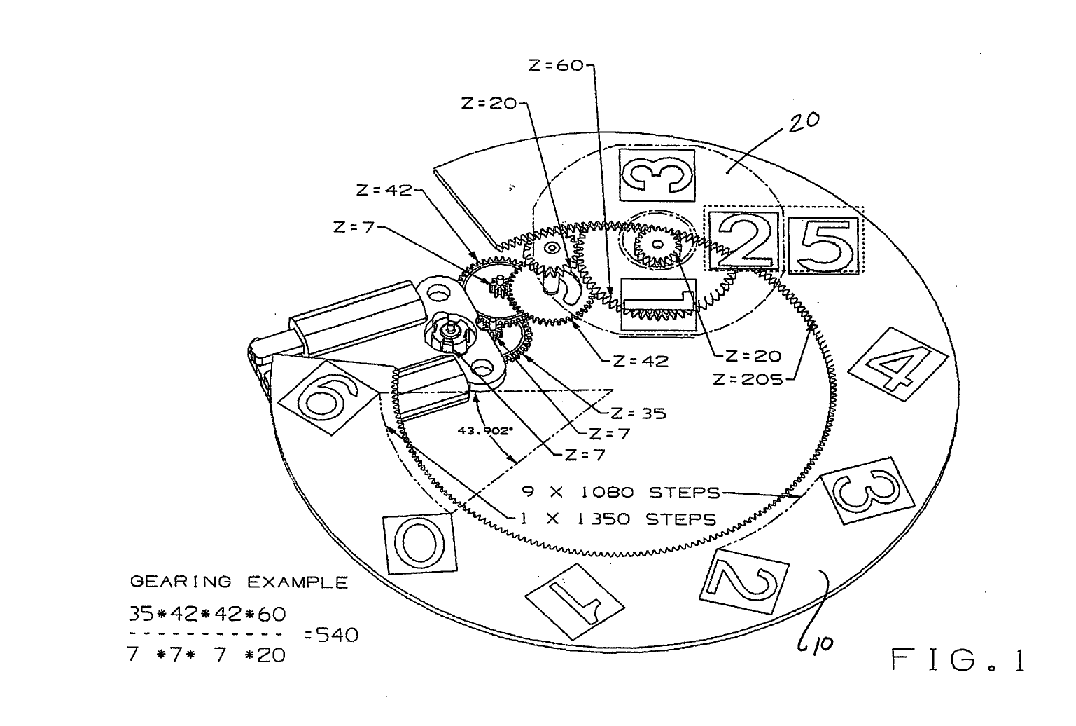

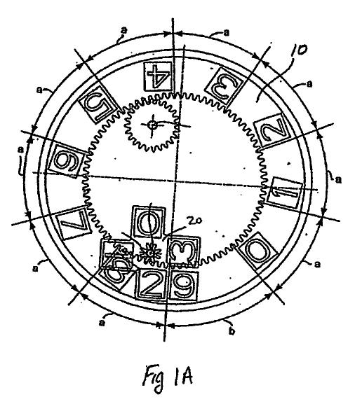

Reference is first made to FIGS. 1 and 1A which illustrate a date display assembly employing the construction set forth in U.S. application Ser. No. 10/407,169. As set forth in the '169 application, each time the units ring is moved by the angular value corresponding to the distance between digits (e.g. 0 to 1, 1 to 2, . . . 8 to 9 (and excepting 9 to 0)) the tens disc carries out a full rotation (i.e. 360°), and when the units ring is moved through an angular value corresponding to the sector between the 9 and 0 digits, the tens disc carries out a whole number turn plus a quarter turn (e.g. 450°). It is clear from FIGS. 1 and 1A that the rotational directions of the units ring and the tens disc are the same. Thus, during passage of the units numerals 0 to 1, 1 to 2 . . . 7 to 8 and 8 to 9 in the clockwise direction, the tens disc carries out one complete revolution (i.e. rotating 360° in the clockwise direction) and the numeral indicating the tenth remains the same. By contrast, during passage of the units numerals from 9 to 0, the tens disc carries out one and a quarter turns such that the numeral of the disc disposed in the window beside a units numeral is incremented by one unit.

FIG. 1 illustrates the foregoing in somewhat greater detail. For example, an exemplary transmission ratio of 540 is employed for rotation of the respective gears, unit ring 10 and tens disc 20. The computation of the transmission ratio is a function of the number of teeth on each gear, ring or disc as the case may be, and the exemplary values (i.e. number of teeth) for each gear/ring/disc are indicated in FIG. 1. Based on these values, the transmission ratio is computed from the equation: (35/7)×(42/7)×(42/7)×(60/20)=540.

Based thereon, it can be seen that 1080 rotor steps (i.e. 2 rotor steps per one complete revolution) are needed to rotate tens disc 20 by 360° when units ring 10 moves from (e.g.) 10 to 11, 11 to 12, . . , 18 to 19. However, as indicated above, movement of the units ring from the 9 to the 0 numeral requires 450° of rotation for tens disc 20 (and 1350 rotor steps of the rotor of stepping motor 30) because of the larger sector (i.e. between the 9 and the 0 digits on the units ring 10) which also thus requires 43.902° of rotation for units ring 10.

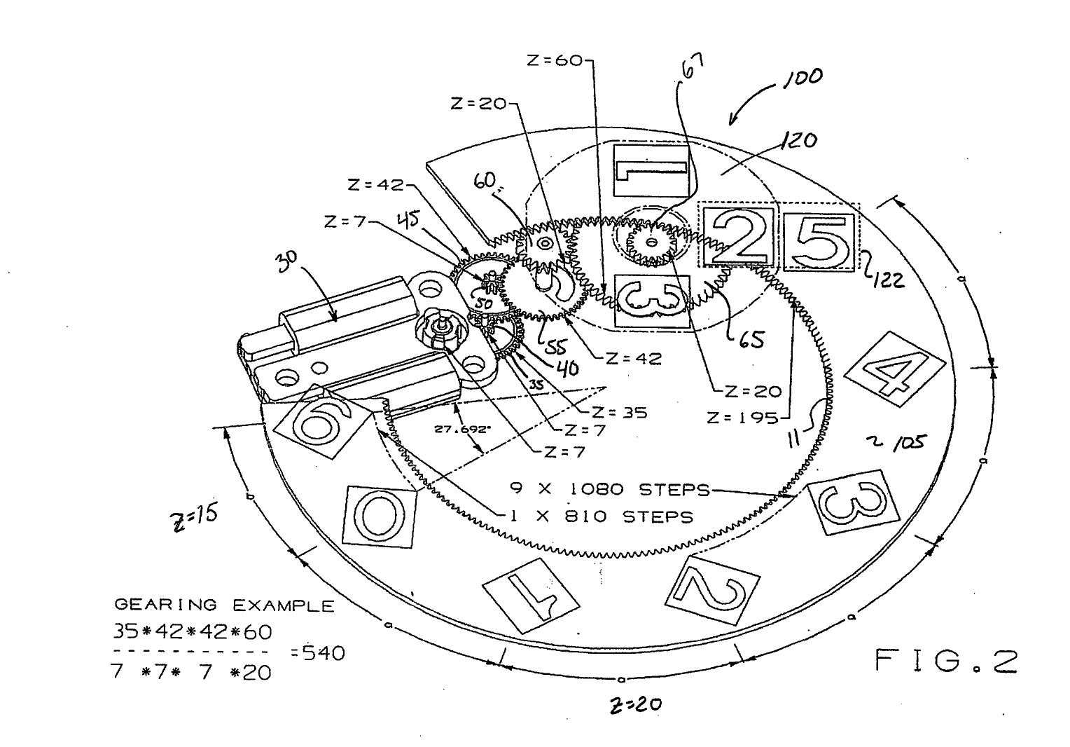

Reference is now made to FIG. 2 for an understanding of the date display assembly, generally indicated at 100, constructed in accordance with the present invention.

As set forth, date display assembly 100 comprises a units ring 105 and a tens disc 120. Units ring 105 comprising a series of numerals from 0 to 9 and tens disc 120 comprises a series of numerals from at least 1 to 3, and optionally the numeral 0 (which can, in the alternative, be a blank). As would be understood in the art, units ring 105 and tens disc 120 are positioned relative to each other so as to display in the space of a window 122 two numerals side by side, one of which is carried by units ring 105 and the other of which is carried by tens disc 120. In accordance with the present invention, the units ring 105 is divided into ten sectors (or a multiple of ten sectors) each bearing a numeral from 0 to 9, and the one sector (“b”) separating the numerals 9 and 0 has an angular extent equal to ¾ of the angular extent of the sectors (“a”) separating the other numerals. That is, the angular extent of all the (“a”) sectors separating all the digits (except for the (“b”) sector separating the 9 and 0) are equal to each other, while the angular extent of the sectors separating the 9 and 0 is ¾ thereof. FIG. 2 illustrates the foregoing in greater detail.

By way of general construction of the invention, date display assembly 100 comprises a motor, generally indicated at 30 and a gearing assembly, comprising one or more wheels operatively coupled to motor 30. Stepping motor 30, which is preferably a bi-directional motor, comprises a rotor that is rotateably coupled to at least a first of the wheels of the gearing assembly. That is, the rotor will preferably comprise teeth that meshingly align with the outer teeth of a first wheel 35. In turn, first wheel 35 includes a pinion 40 which itself has teeth that meshingly align with teeth on the outer circumference of a second wheel 45. Second wheel 45 comprises a pinion 50 which itself has teeth that meshingly align with teeth on the outer circumference of a third wheel 55. This third wheel 55 likewise comprises a pinion 60 which itself has teeth that meshingly align with teeth on the outer circumference of tens disc driving wheel 65. In this way, the rotation of rotor 52 of motor 30 can cause the rotation of tens disc 120. Finally, wheel 65 comprises a pinion 67 so that there may be final meshing between the pinion 67 of wheel 65 and inner teeth 11 of units ring 105. As indicated above, it should be understood that the number of wheels and number of teeth on each wheel may be more or less (or different as the case may be) than that set forth herein, and are really one of design choice for the intended function and based upon a number of known criterions, such as power and torque constraints. The selection of a suitable stepping motor and the arrangement and/or positioning of the components are all within the purview of one skilled in the art.

As would be understood by one skilled in the art, while movement of units ring 105 (when moving between all digits except for that between 9 and 0) brings about a rotation of 360° for tens disc 120, the embodiment of FIG. 2 requires only a 270° rotation for the tens disc, and 27.692° of rotation for unit ring 105 when moving between numerals 9 and 0. As would be understood, this requires only 810 rotor steps. Thus, as but just one advantage over the cited art, the display assembly of the present invention is able to rotate tens disc 120 faster than that provided in the cited art. As would also be understood in the embodiment of FIG. 2, rotation of units ring 105 from the 9 to the 0 digit would be in the clockwise direction and the corresponding direction of rotation of tens disc 120 to display the next correct tens digit would also be in the clockwise direction. Obviously, rotating the units ring in reverse would imply a corresponding reversal of directional rotation to the tens disc.

Additionally, the gear ratio between the tens disc 120 and units ring 105 for the embodiment of FIG. 2 is more efficient and improved over that seen in the FIG. 1 construction. For example, as set forth in the respective figures, the tens disc is preferably provided with a set number of teeth, i.e. 20. The corresponding number of teeth however for the units ring of FIG. 2 requires only 195=(9*20+(¾)*20) teeth, while the correspondingly constructed units ring of FIG. 1 requires 205=(9*20+(5/4)*20) teeth. Accordingly, because of the reduced number of required teeth for units ring 105 (e.g. 195 vs. 205), the present invention permits a larger module (about 5%) than permitted by the prior art for a similarly dimensioned (i.e. given) center distance between the respective tens disc and units ring.

To assist in the understanding of the present invention, “z” indicates the number of teeth on the particularly identified wheel. The meshing engagement therebetween is well within the purview of one skilled in the art, and certain minor modifications (while still maintaining the essence of the invention set forth herein) may be made without altering the present invention. To be sure, the sectors “a” between the numerals 0 and 1, 1 and 2, 2 and 3, 3 and 4, 4 and 5, 5 and 6, 6 and 7, 7 and 8, and 8 and 9 all have an arcuate length thus equal to an identical number of teeth of the internal teeth on the inner surface of units ring 105. The sector “b” between the numerals 9 and 0 of the units ring 105 extends over an arc lesser than that of sectors “a” and which hence comprises less teeth than sectors “a” as set forth above.

Display assembly 100 may be controlled by a controller (not shown) but set forth in several applications coowned and copending herewith, and the construction of such a controller would be well understood by one skilled in the art. For example, the subject matter of application Ser. No. 10/716,011, entitled “Perpetual Calendar For a Timepiece” and incorporated by reference as if fully set forth herein, discloses details of a controller and other features that can be integrated into the embodiment of the present invention.

As illustrated in FIG. 2, stepper motor 30 preferably drives via the intermediate wheels mentioned above, tens disc 120, which in turn drives the units ring 105. Alternatively, motor 30 may merely drive the units ring 105 while an (optional) intermediate wheel, driven by the units ring 105, drives tens disc 120, similar to the manner in which ring 10 of FIG. 1A drives tens disc 20.

In operation, when units ring 105 is moved by the angular value corresponding to a sector “a,” tens disc 120 carries out one complete revolution and when units ring 105 is moved through an angular value corresponding to sector “b,” tens disc 120 rotates only 270°.

The controller (not shown) is programmed to advance the ring and/or gears appropriately to achieve the foregoing rotation. It is evident that the electronic control circuit of the micromotor can be provided to take account of the months of 28, 30 and 31 days, as well as the leap years. It is thus easy to provide a display of the day of the month which will be annual or perpetual. At the end of a month of 31 days, 30 days, 28 days or a leap year, the controller will cause motor 30 to step the correct number of steps to effectuate the displaying of “01” in the window of the timepiece face.

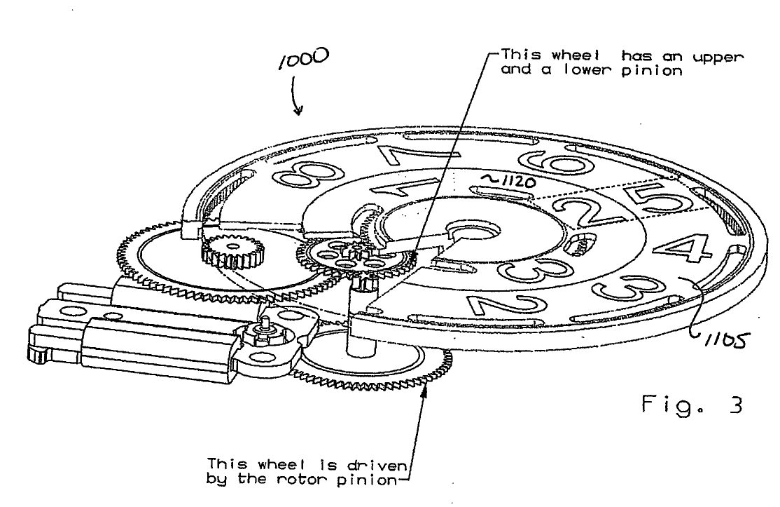

Reference is briefly now made to FIG. 3, which illustrates yet a modification of the embodiment of FIG. 2. Here, the modification of date display assembly 1000 can best be seen by the tens disc 1120 and the units ring 1105 clearly mounted in the same plane. This construction permits the construction of a thinner module (and hence a thinner timepiece), and further provides the advantage that the optical problem of seeing the tens digit closer to the eye is avoided. Additionally, providing the tens disc 1120 and the units ring 1105 in the same plane assists in limiting axial displacement similar to the idea set forth in copending and coowned application Ser. No. 10/342,512. Also, in this exemplary embodiment, the gearing is such that the tens disc 1120 rotates in the same direction as units ring 1105, although one skilled in the art would appreciate that the embodiment of FIG. 3 could be made for opposite rotating directions of the tens disc and ones ring by adding an intermediate wheel, if desired or necessary. Here too, the tens disc preferably drives the units ring, although in an alternative construction, motor 30 may drive the units ring 1105 and the tens disc 1120 together, via one or more intermediate wheels as shown in FIG. 3, whereby one intermediate pinion meshes with both the units ring and the tens disc.

For completeness, the disclosure of U.S. patent applicant Ser. No. 10/407,169, to the extent it is not in conflict with the present invention, is incorporated by reference as if fully set forth herein. For example, certain minor details to the extent they are applicable to the present invention, are incorporated by reference to avoid unnecessary descriptions herein. Also, it is intended that all indications set forth in the drawings of the present invention, if not explicitly indicated herein are incorporated by reference as if fully set forth herein, such as the gearing ratios and number of teeth per ring, disc or wheel, as but some examples.

It can thus be seen that the present invention provides numerous advantages not found in the prior art. For example, the present invention provides an improved date display assembly that requires less rotation of the tens disc, thus minimizing the energy and rotation time needed, thereby simultaneously providing a more efficient and reliable date display methodology as well as a larger display capability.

While the invention has been particularly shown and described with respect to preferred embodiments thereof, it will be understood by those skilled in the art that changes in form and details may be made therein without departing from the scope and spirit of the invention.

What is claimed is:

1. A date display assembly for displaying the day of the month in an electronic device, the assembly comprising:
a units ring and a tens disc, the units ring comprising at least one series of numerals from 0 to 9 and the tens disc comprising a series of numerals from at least 1 to 3 and optionally the numeral 0;
wherein the units ring and the tens disc are positioned relative to each other so as to display in the space of a window two numerals side by side, one of which is carried by the units ring and the other of which is carried by the tens disc,
wherein the units ring is divided into ten sectors each of which separate two numerals in the series of numerals from 0 to 9, the one sector separating the numerals 9-0 having an angular extent equal to ¾ of the angular extent of the sectors separating the other numerals.

2. The assembly as claimed in claim 1, wherein all the sectors of the units ring bearing a number from 0 to 8 comprise the same number of teeth,
wherein the number of teeth of the units ring corresponding to the sector separating the numerals 9 and 0 is equal to ¾ times the number of teeth corresponding to the sectors of the units ring separating the numerals 0 and 1, 1 and 2, 2 and 3, 3 and 4, 4 and 5, 5 and 6, 6 and 7, 7 and 8, and 8 and 9.

3. The assembly as claimed in claim 1, wherein the tens disc carries out a complete revolution with each successive angular rotation of the units ring from the display of 0 to 1 in the window, from the display of 1 to 2, and from the display of each successive numeral through the display of numeral 9,
except that the tens disc only rotates 270° when the units ring rotates from the display of 9 to 0 in the window.

4. The assembly as claimed in claim 1, wherein the units ring comprises a single series of numerals from 0 to 9 and that the tens disc comprises a single series of numerals 0 to 3.

5. A wristwatch incorporating the date display assembly of claim 1.

6. An electronic device that comprises a dial having a window and a date display assembly for displaying the date, wherein the date is displayed in the window of the dial, wherein the electronic device comprises:
a gearing assembly comprising one or more rotateable wheels;
an actuation mechanism for rotating the one or more wheels of the gearing assembly;
a controller for causing the rotation of the actuation mechanism;
wherein the date display assembly comprises:
a units ring and a tens disc, the units ring comprising at least one series of numerals from 0 to 9 and the tens disc comprising a series of numerals from at least 1 to 3 and optionally the numeral 0;
wherein the units ring and the tens disc are positioned relative to each other so as to display in the window two numerals side by side, one of which is carried by the units ring and the other of which is carried by the tens disc,
wherein the units ring is divided into ten sectors each of which separate two numerals in the series of numerals from 0 to 9, the one sector separating the numerals 9-0 having an angular extent equal to ¾ of the angular extent of the sectors separating the other numerals; and
wherein the gearing assembly is operatively coupled to the date display assembly for rotating the tens disc and the units ring under the control of the controller.

7. The electronic device as claimed in claim 6, wherein all the sectors of the units ring separating the numerals 0 and 1, 1 and 2, 2 and 3, 3 and 4, 4 and 5, 5 and 6, 6 and 7, 7 and 8, and 8 and 9 comprise the same number of teeth,
wherein the number of teeth of the units ring corresponding to the sector separating the numerals 9 and 0 is equal to ¾ times the number of teeth corresponding to the sectors of the units ring separating the other numerals.

8. The electronic device as claimed in claim 6, wherein the tens disc carries out a complete revolution with each successive angular rotation of the units ring from the display of 0 to 1 in the window, from the display of 1 to 2, and from the display of each successive numeral through the display of numeral 9,
except that the tens disc only rotates 270° when the units ring rotates from the display of 9 to 0 in the window.

9. The electronic device as claimed in claim 6, wherein the units ring comprises a single series of numerals from 0 to 9 and that the tens disc comprises a single series of numerals 0 to 3.

10. The electronic device as claimed in claim 6, wherein the electronic device is a wristwatch.

11. The electronic device as claimed in claim 6, wherein the gearing assembly directly drives the tens disc and the rotation of the tens disc causes the rotation of the units ring.
